(19) United States
(12) Patent Application Publication
(10) Pub. No.: US 2026/0241335 A1
(43) Pub. Date: Aug. 20, 2026

(54) INTEGRATING ENHANCED ROCK WEATHERING AND TURF MANAGEMENT TO SEQUESTER ATMOSPHERIC CARBON DIOXIDE

(71) Applicants: Brian Morrison, Miami, FL (US); Trustees of Dartmouth College, Hanover, NH (US)

(72) Inventors: Brian Morrison, Miami, FL (US); Mukul Sharma, Hanover, NH (US)

(21) Appl. No.: 19/161,864

(22) PCT Filed: Mar. 4, 2024
(86) PCT No.: PCT/US2024/018316

§ 371 Date: Sep. 3, 2025

Related U.S. Application Data
(60) Provisional application No. 63/449,791, filed on Mar. 3, 2023.

(51) Int. Cl. B01D 53/62; A01G 20/00; B01D 53/78; C04B 14/14; C04B 14/28; C04B 111/00

(52) U.S. Cl. CPC B01D 53/62; A01G 20/00; B01D 53/78; C04B 14/14; C04B 14/28; B01D 2251/304; B01D 2251/402; B01D 2251/404; B01D 2257/504; B01D 2258/06; C04B 2111/00019

(57) ABSTRACT

Embodiments of the present disclosure pertain to compositions that include at least one basalt sand that is in the form of crushed particles. Additional embodiments of the present disclosure pertain to methods of modifying a surface by applying a composition of the present disclosure to the surface. Further embodiments of the present disclosure pertain to modified surfaces that include the compositions of the present disclosure, methods of capturing carbon dioxide (CO₂) from an environment by exposing the environment to a composition of the present disclosure, and methods of making the basalt sand compositions of the present disclosure.

### CROSS-REFERENCE TO RELATED APPLICATIONS

The present application claims the benefit of U.S. Provisional Patent Application No. 63/449,791, filed on Mar. 3, 2023. The entirety of the aforementioned application is incorporated herein by reference.

### BACKGROUND

Current methods of capturing carbon dioxide (CO₂) have numerous limitations in terms of efficacy, efficiency, costs, and the ability to capture CO₂ at a large scale. Numerous embodiments of the present disclosure address the aforementioned limitations.

### SUMMARY

In some embodiments, the present disclosure pertains to compositions that include at least one basalt sand that is in the form of crushed particles. In some embodiments, the basalt sand is in purified form. In some embodiments, the basalt sand includes pre-treated basalt sand. In some embodiments, the basalt sand includes a plurality of different types of basalt sands. In some embodiments, the basalt sands of the present disclosure may be in the form of course particles, medium particles, course-grained particles, fine-grained particles, ultra-fine particles, nanoparticles, microparticles, or combinations thereof. In some embodiments, the basalt sands may be mixed with other sands and/or soil additives.

The basalt sands of the present disclosure may include various compounds. For instance, in some embodiments, the compounds may include, without limitation, CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄, or combinations thereof. In some embodiments, the basalt sand compositions of the present disclosure include, without limitation, plagioclase feldspars-containing basalt, pyroxenes-containing basalt, tholeiites, Holyoke Basalts, Blue Ridge Basalts, Butner Basalts, or combinations thereof.

Additional embodiments of the present disclosure pertain to methods of modifying a surface by applying a composition of the present disclosure to the surface. In some embodiments, the compositions of the present disclosure are placed on an outer layer of the surface. In some embodiments, the methods of the present disclosure may also include a step of removing an outer layer of a surface prior to applying a composition of the present disclosure to the surface. In some embodiments, the methods of the present disclosure also include a step of integrating the compositions of the present disclosure with a surface (e.g., within the topsoil and/or rootzone of a turf).

Additional embodiments of the present disclosure pertain to modified surfaces that include a composition of the present disclosure. Further embodiments of the present disclosure pertain to methods of capturing carbon dioxide (CO₂) from an environment by exposing the environment to a composition of the present disclosure.

Additional embodiments of the present disclosure pertain to methods of making the basalt sand compositions of the present disclosure. In some embodiments, such methods include crushing at least one basalt sand such that the crushing results in the formation of crushed basalt sand particles. In some embodiments, the methods of the present disclosure also include a step of isolating, filtering, and/or drying the basalt sand.

### DESCRIPTION OF THE DRAWINGS

FIGS. 1A-IC illustrate an exemplary process for applying a composition of the present disclosure to a surface to form a modified surface. In some embodiments, such a process is referred to as a full rootzone basalt sand integration process.

FIGS. 2A-2B illustrate another exemplary process for applying a composition of the present disclosure to a surface to form a modified surface. In some embodiments, such a process is referred to as a top sand only basalt sand integration process.

FIGS. 3A-3C illustrate another exemplary process for applying a composition of the present disclosure to a surface to form a modified surface. In some embodiments, such a process is referred to as a basalt enhanced top sanding and aeration process, which can be used as part of ongoing aeration and top sanding programs to form a modified surface.

FIGS. 4A-4C illustrate another exemplary process for applying a composition of the present disclosure to a surface to form a modified surface. In some embodiments, such a process is referred to as a full rootzone basalt sand integration process.

FIG. 5 illustrates the locations of top 99 Golf Courses in the United States in relation to three major geologic provinces with basalt.

FIG. 6 shows the particle size distribution of Pioneer Valley basalt from Rock Dust Local (rockustlocal.com).

FIGS. 7A-7B provide an experimental setup (FIG. 7A) and experimental results (FIG. 7B) demonstrating that soil amended with basalt powder releases six-times more alkalinity than the control soil.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Climate change fundamentally threatens the safety and stability of modern civilization. In order to avoid the increasingly disastrous and costly effects of climate change, net atmospheric concentrations of greenhouse gases must be reduced. Such reductions can be achieved through improvements in productive efficiency (e.g., reducing CO₂ emissions while maintaining output) and carbon dioxide (CO₂) removal (CDR).

Enhanced rock weathering (ERW) is an example of a CDR-based approach that aims to take atmospheric Carbon (CO₂) out of air and store it as bicarbonate or carbonate. ERW has been investigated in cropland but not in golf courses or other managed turfs. Several different types of materials have been used for ERW, including peridotite, basalt, slag, and mine-tailings. Furthermore, ERW has beneficial effects on soil health by releasing beneficial mineral nutrients into the soil, such as calcium, potassium, phosphorous, and magnesium.

However, ERW-based CDR processes utilizing peridotites, mine tailings, slag, and basalt other than tholeiites have numerous limitations. Foremost among them is the potential release of heavy metals to the environment and slow weathering kinetics. Furthermore, manufacturing large amounts of basalt powder (including mining, crushing, sorting, and shipping) can be an energy intensive process. Moreover, there is additional energy required to apply the basalt powder multiple times throughout the growing season with specialized spreading equipment that is typically gas powered. These costs and methods to spread the products for ERW would be especially difficult in places where this spreading is not common practice. This results in increased development costs and increased energy consumption. Such limitations may render ERW-based CDR processes inefficient and impractical for large scale CO₂ capture from large surface areas.

In comparison, golf course greens and courses at large, which, in general, are intensively managed, already engage in this top sanding process. They own and have the technical expertise to spread large amounts of sand onto the turf surface and rootzone. There are large amounts of research into turf grass and golf course maintenance practices aiding the development and deployment of basalt sands within existing maintenance and construction. Additionally, Golf courses have many characteristics that make them ideal to engender CDR through ERW as they are frequently located in warm and hot climates, are frequently watered and receive precipitation, and have high levels of primary productivity leading to turfs generating large amounts of organic matter—three parameters that increase the weathering rate.

In sum, current methods of capturing CO₂ have numerous limitations in terms of efficacy, efficiency, costs, and the ability to capture CO₂ from large surface areas. Numerous embodiments of the present disclosure address the aforementioned limitations.

### Basalt Sand Compositions

In some embodiments, the present disclosure pertains to compositions that include at least one basalt sand. Basalt is the name of a mafic aphanitic volcanic rock that includes, without limitation, tholeiites. Basalt is exposed around the world on the continents and at the ocean floor.

The basalt sands of the present disclosure may be in various forms. For instance, in some embodiments, the basalt sand is in isolated form (i.e., basalt sand isolated from its native environment). In some embodiments, the basalt sand is in the form of crushed particles. In some embodiments, the basalt sand is in purified form. In some embodiments, the basalt sand includes pre-treated basalt sand. In some embodiments, the basalt sands of the present disclosure may be in the form of course particles, medium particles, course-grained particles, fine-grained particles, ultra-fine particles, nanoparticles, microparticles, or combinations thereof.

The basalt sands of the present disclosure may include various compounds. For instance, in some embodiments, the compounds may include, without limitation, CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄, or combinations thereof.

The compositions of the present disclosure may include various types of basalt sands. In some embodiments the basalt sand includes a plurality of different types of basalt sands. In some embodiments, the basalt sand includes, without limitation, plagioclase feldspars-containing basalts, pyroxenes-containing basalts, tholeiites, Holyoke Basalts, Blue Ridge Basalts, Butner Basalts, or combinations thereof.

In some embodiments, the basalt sand compositions of the present disclosure include plagioclase feldspars-containing basalts and pyroxenes-containing basalts. In some embodiments, the basalt sand compositions of the present disclosure include microscopic or visible plagioclase feldspars-containing basalts and pyroxenes-containing basalts, with little or no olivines, and with minor iron spinel and phosphate.

In some embodiments, the basalt sand compositions of the present disclosure include tholeiites. In some embodiments, the basalt sand compositions of the present disclosure include tholeiites with low heavy metal concentrations.

In some embodiments, the basalt sand compositions of the present disclosure include Holyoke Basalt. In some embodiments, the Holyoke Basalt is derived from Massachusetts (MA). In some embodiments, the average concentrations of Cr, Ni, Cu, Zn, and Pb in Holyoke Basalt are 13 ppm, 33 ppm, 78 ppm, 86 ppm, and 4 ppm, respectively. In some embodiments, the average concentrations of Cr, Ni, Cu, Zn, and Pb in Holyoke Basalt are 384 ppm, 75 ppm, 145 ppm, 88 ppm, and 1.5 ppm, respectively. In some embodiments, Holyoke Basalt is essentially devoid of visible crystals. In some embodiments, Holyoke Basalt is in non-crystalline form. In some embodiments, Holyoke Basalt includes the following elements: SiO₂, TiO₂, Al₂O₃, Fe₂O₃, FeO, CaO, MgO, MnO, K₂O, Na₂O, and P₂O₅.

In some embodiments, the basalt sand compositions of the present disclosure include Butner Basalt. In some embodiments, the Butner Basalt is derived from North Carolina (NC). In some embodiments, Butner Basalt is essentially devoid of visible crystals. In some embodiments, Butner Basalt is in non-crystalline form.

In some embodiments, Holyoke Basalt and Butner Basalt each include the following elements: SiO₂, TiO₂, Al₂O₃, Fe₂O₃, FeO, CaO, MgO, MnO, K₂O, Na₂O, and P₂O₅. In some embodiments, the aforementioned elements are present at average weight percentages listed in Table 1.

TABLE 1
Average weight percentages of major elements of Holyoke
and Butner Basalts. The data are averages of published
results downloaded from GEOROC.org.

| | Holyoke | Butner |
|---|---|---|
| Element | Basalt, MA | Basalt, NC |
| SiO₂ | 52.60 | 49.9 |
| TiO₂ | 0.96 | 0.66 |
| Al₂O₃ | 14.14 | 16.27 |
| Fe₂O₃ | 2.37 | (*) |
| FeO | 9.72 | 10.65 |
| CaO | 9.98 | 11.45 |
| MgO | 6.20 | 8.24 |
| MnO | 0.21 | 0.17 |
| K₂O | 0.61 | 0.38 |
| Na₂O | 2.67 | 2.14 |
| P₂O₅ | 0.09 | 0.10 |
| E_{POT} (**) | 219 | 270 |

(*) FeO for Butner basalt reflects the total amount of iron present without making a distinction between Fe(II) and Fe(III).
(**) E_{POT} is the maximum enhanced weathering CO₂ capture potential in units of kg CO₂ t⁻¹ (as defined in Renforth (2019) The negative emission potential of alkaline materials. Nature Comm. https://doi.org/10.1038/s41467-019-09475-5).

The basalt sands of the present disclosure may include various particle shapes. For instance, in some embodiments, the basalt sand particles of the present disclosure may be angular or rounded depending on their application. In some embodiments, different proportions of basalt sand particle sizes and blends may be used to best suit the local conditions. For instance, in some embodiments, finer sands may retain more moisture within an upper rootzone of a soil. In some embodiments, such sands may also include reduced moisture content through various treatment methods (e.g., kiln drying) so that they can be applied to a surface more effectively (e.g., more efficient spreading using golf course sand spreading and aeration equipment).

The compositions of the present disclosure may also include additional components. For instance, in some embodiments, the compositions of the present disclosure may also include one or more additives. In some embodiments, the one or more additives include, without limitation, silicates, microbes, fungi, bacteria, actinomyces, biochar, golf course additives, peat moss, top sand, quartz-based top sands, lime, or combinations thereof.

In some embodiments, the additives include one or more golf course additives. In some embodiments, the golf course additives include, without limitation, peat moss, quartz-based top sands, lime, or combinations thereof. In some embodiments, the quartz-based top sands are utilized to dilute the basalt. In some embodiments, the basalt sand compositions of the present disclosure may be treated with such additives depending on the needs of a surface (e.g., a local soil).

### Methods of Modifying a Surface

Additional embodiments of the present disclosure pertain to methods of modifying a surface. In some embodiments, such methods include applying a composition of the present disclosure to the surface. Suitable compositions were described supra and are incorporated herein by reference.

The compositions of the present disclosure may be applied to surfaces in various manners. For instance, in some embodiments, the compositions of the present disclosure may be applied by methods that include, without limitation, spreading, pouring, sprinkling, spraying, or combinations thereof. In some embodiments, the compositions of the present disclosure are placed on an outer layer of the surface. In some embodiments, the compositions of the present disclosure may become integrated with the surface. In some embodiments, the methods of the present disclosure may also include a step of removing an outer layer of a surface prior to applying a composition of the present disclosure to the surface.

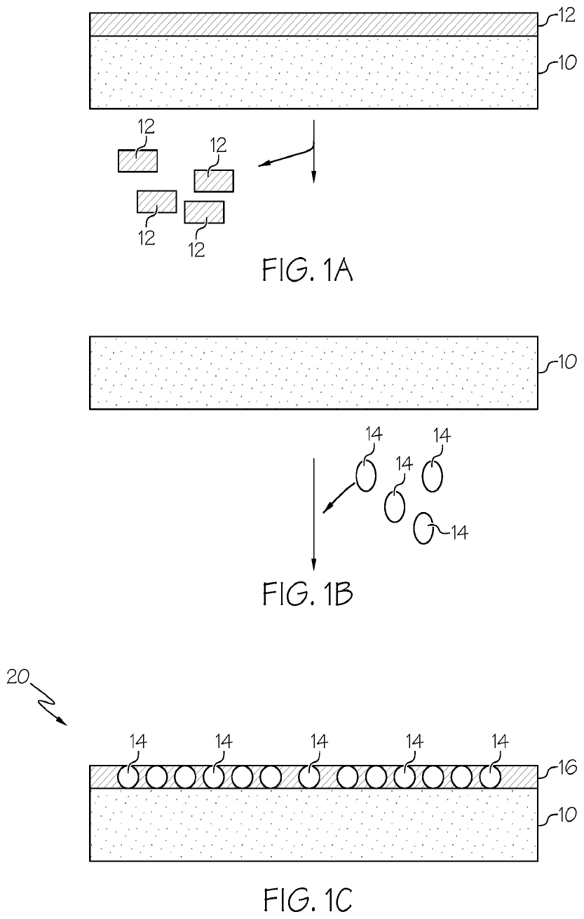

FIGS. 1A-IC, 2A-2B, 3A-3C, and 4A-4C illustrate exemplary processes for applying a composition of the present disclosure to a surface. For instance, FIGS. 1A-1C illustrate an exemplary process for applying a composition of the present disclosure (i.e., basalt sand 14) to a surface 10 with an outer layer 12. In this example, outer layer 12 is first removed from surface 10 (FIG. 1A). Thereafter, basalt sand 14 is applied to surface 10 (FIG. 1B) to form a new outer layer 16 on surface 10, which contains basalt sand 14 (FIG. 1C).

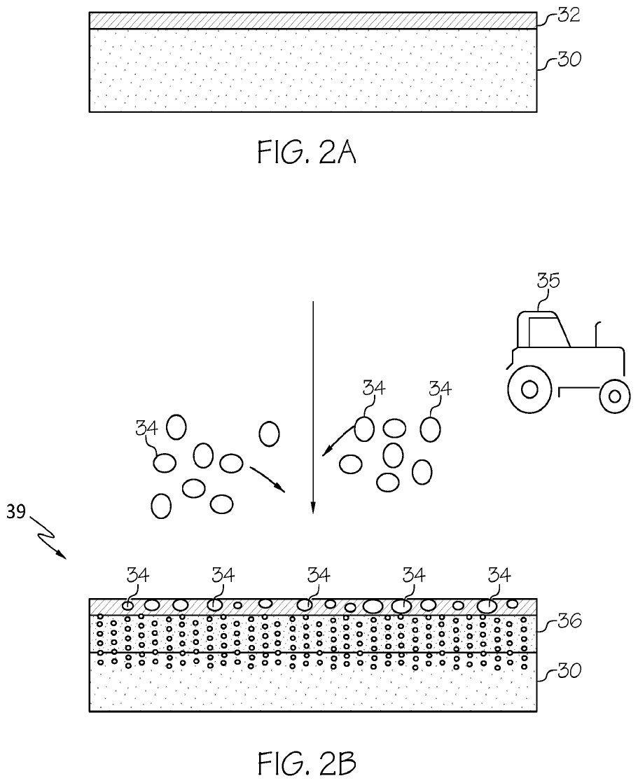

FIGS. 2A-2B show an example of a more specific process to integrate an existing surface (i.e., a top sand 30 of a golf course) with a composition of the present disclosure (i.e., basalt sand 34) to build up a new outer layer 36 where basalt sands 34 are integrated in the top sand 30 of the greens and turf surface generally. As illustrated in FIG. 2A, basalt sand 34 is applied to top sand 30 of a golf course with an outer layer (i.e., the grass and rootzone 32). In some embodiments, basalt sand 34 may be applied with agricultural spreaders, such as equipment 35, to top sand 30. As illustrated in FIG. 2B, the application of basalt sands 34 forms a new outer layer 36 on surface 30, which contains composition 34 integrated into surface 30 (FIG. 2B).

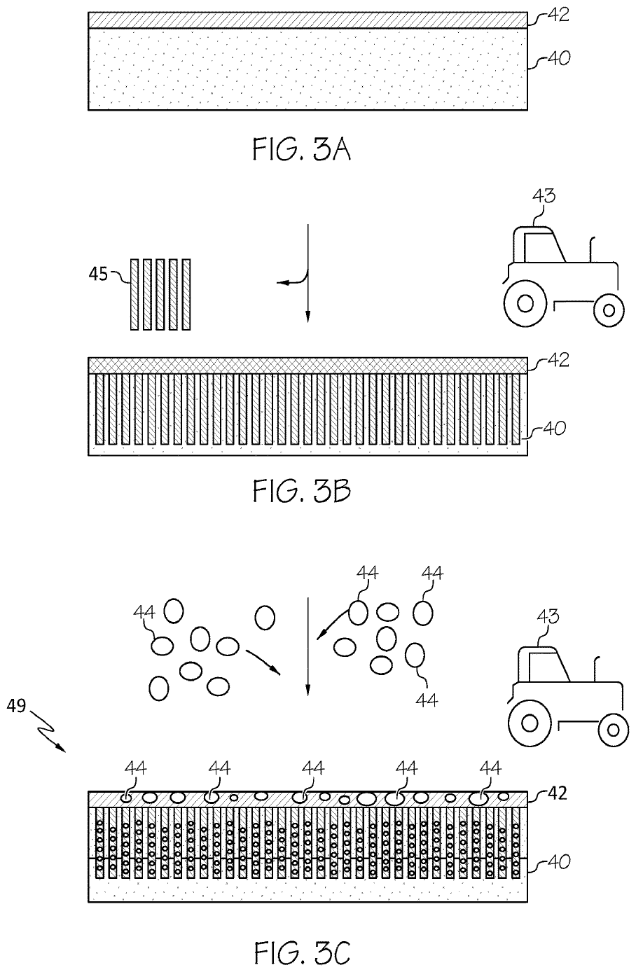

FIGS. 3A-3C show another specific method of integrating the compositions of the present disclosure (i.e., basalt sand 44) into a surface (i.e., a top sand 40 with topsoil 42) by using aeration as a chance to rapidly integrate larger amounts of basalt sands 44 deeper into the root zone of top sand 40. In this Example, equipment 43 is used to punch holes 45 into surface 40 of the grass. In some embodiments, such as process may remove around 10% of the organic matter dense root zone and topsoil 42 (FIGS. 3A-3B). Thereafter, the same spreading equipment 43 may be used to backfill holes 45 with basalt sands 44 (FIGS. 3B-3C). This process is not only beneficial for managing organic matter in the surface and overall grass health, but also will allow basalt sands to penetrate deeper into the surface of the green.

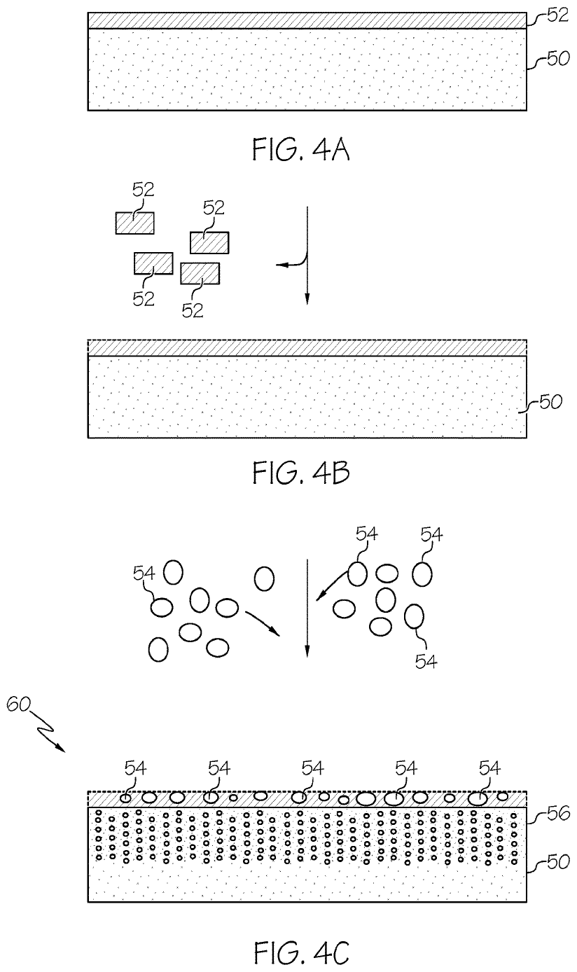

FIGS. 4A-4C show another specific method to integrate the compositions of the present disclosure (i.e., basalt sands 54) into a surface (i.e., top sand 50 with an outer layer 52). In this example, outer layer 52 is first removed from surface 50 (FIG. 4A). Thereafter, composition 54 is applied to surface 50 (FIG. 4B) to form a new outer layer 56 on surface 50, which contains composition 54 (FIG. 4C). In some embodiments, this option allows for a large amount of basalt sand to be used as the entire soil profile will be entirely rebuilt and basalt sands can be included in the blend as well as in the sand spread into the rootzone as the grass is regrown.

The compositions of the present disclosure may be applied to a surface at various concentrations. For instance, in some embodiments, the compositions of the present disclosure are applied at a concentration of at least about 0.1 ton per acre of the surface per year. In some embodiments, the compositions of the present disclosure are applied at a concentration of at least about 0.5 ton per acre of the surface per year. In some embodiments, the compositions of the present disclosure are applied at a concentration of at least about 1 ton per acre of the surface per year. In some embodiments, the compositions of the present disclosure are applied at a concentration of at least about 2 tons per acre of the surface per year. In some embodiments, the compositions of the present disclosure are applied at a concentration of at least about 2.5 tons per acre of the surface per year. In some embodiments, the compositions of the present disclosure are applied at a concentration of at least about 5 tons per acre of the surface per year. In some embodiments, the compositions of the present disclosure are applied at a concentration of at least about 7.5 tons per acre of the surface per year. In some embodiments, the compositions of the present disclosure are applied at a concentration of at least about 10 tons per acre of the surface per year. In some embodiments, the compositions of the present disclosure are applied at a concentration of at least about 25 tons per acre of the surface per year. In some embodiments, the compositions of the present disclosure are applied at a concentration of at least about 50 tons per acre of the surface per year. In some embodiments, the compositions of the present disclosure are applied at a concentration of at least about 75 tons per acre of the surface per year. In some embodiments, the compositions of the present disclosure are applied at a concentration of at least about 100 tons per acre of the surface.

The compositions of the present disclosure may be applied to a surface at varying levels of frequency. For instance, in some embodiments, the compositions of the present disclosure may be applied to a surface from one time to twenty times per year. In some embodiments, the compositions of the present disclosure may be applied to a surface from one time to five times per year.

In some embodiments, full aeration and backfilling holes of a surface may only be done one to five times per year. Since a larger volume of soil may be removed through aeration, more top sand may be needed during aeration than regular top sanding.

The compositions of the present disclosure may be applied to various surfaces. For instance, in some embodiments, the surface is associated with a field. In some embodiments, the field includes an agricultural field, a residential field, a golf course, a park, a sports facility, a yard, a highway, a subdivision, or combinations thereof.

In some embodiments, the field includes managed turf. In some embodiments, the managed turf is in the form of a monoculture. In some embodiments, the managed turf may require constant attention and maintenance as well as a high amount of nutrients and agricultural additives to keep the turf growing consistently.

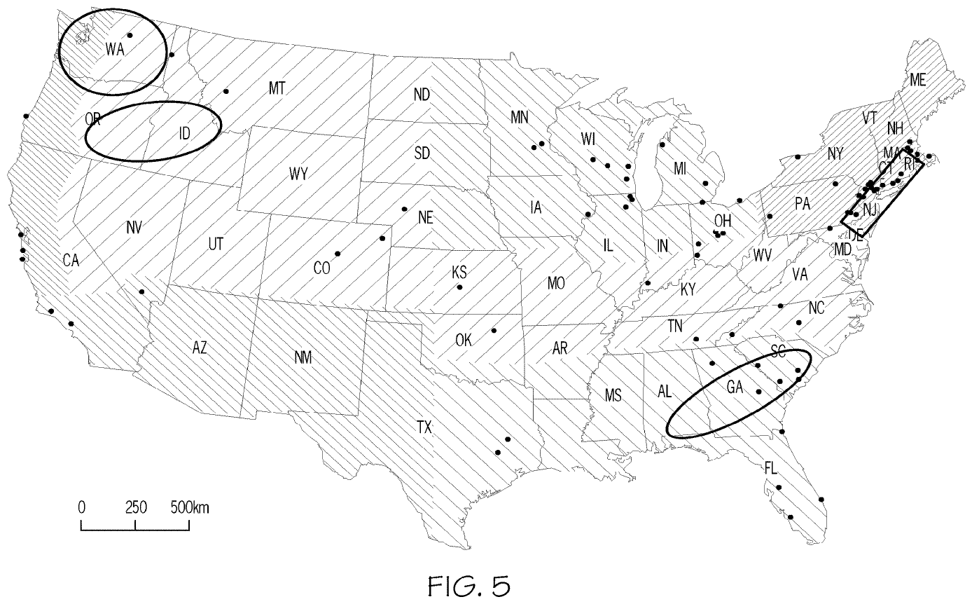

In some embodiments, the field includes a golf course. In some embodiments, the golf course includes a USGA accredited golf course, such as, but not exclusive to the accredited golf courses outlined in FIG. 5.

In some embodiments, the surface includes a soil. In some embodiments, the soil includes, without limitation, top sand, topsoil, a turf, a managed turf, a soil layer below grass, or combinations thereof. In some embodiments, the surface includes a soil layer below grass. In some embodiments, the surface includes a soil layer below grass and its root zones.

In some embodiments, the methods of the present disclosure also improve the quality of the soil. For instance, in some embodiments, the improved soil quality includes at least one of nutrient enhancement, enhanced CO₂ capture, enhanced soil fertility, enhanced soil health, optimization of soil pH, or combinations thereof. As an example, soils developed on Holyoke Basalt as well as Blue ridge basalts have higher pH than those developed on surrounding rocks. They are also richer in nutrients, especially exchangeable Ca and Mg than soil. Table 2 compares soil pH, Organic Matter (OM) and cations on soils developed on north and south sides of ridges made of Holyoke Basalt in Massachusetts. Here, the concentrations are in ppm and uncertainties given in parentheses. The soils developed on Holyoke Basalt have low concentrations of heavy metals.

TABLE 2
A comparison of soil pH, Organic Matter (OM) and cations on
soils developed on north and south sides of ridges made of
Holyoke Basalt in Massachusetts (data is from Karen B. Searcy,
Brayton F. Wilson and James H. Fownes, The Journal of the
Torrey Botanical Society, 2003, 130 (3), pp. 158-169).

| | North Slope | South Slope |
|---|---|---|
| Slope (%) | 37.04 | 31.13 |
| pH | 4.68 | 4.97 |
| OM (%) | 41 | 26 |
| Ca | 2306 | 2454 |
| K | 215 | 159 |
| Mg | 280 | 264 |
| P | 19.5 | 16.5 |
| Al | 213 | 144 |
| B | 0.53 | 0.62 |
| Cd | 0.30 | 0.15 |
| Cu | 1.89 | 1.25 |
| Fe | 65.6 | 52.2 |
| Mn | 86.5 | 35.1 |
| Ni | 0.52 | 0.31 |
| Pb | 19.7 | 11.7 |
| Zn | 20.2 | 8.4 |

In some embodiments, the improved soil quality provides various advantages. For instance, in some embodiments, the improved soil quality reduces or eliminates a need for the use of one or more soil nutrients, one or more soil fertilizers, additives (e.g., lime), or combinations thereof.

### Modified Surfaces

Additional embodiments of the present disclosure pertain to modified surfaces. In some embodiments, the modified surfaces of the present disclosure include a composition of the present disclosure. Suitable compositions were described supra and are incorporated herein by reference.

The compositions of the present disclosure may be associated with surfaces in various manners. For instance, in some embodiments, the compositions of the present disclosure are positioned on an outer layer of the surface. FIG. 1C illustrates an example of a modified surface 20. In this example, modified surface 20 includes surface 10 with an outer layer 16 that contains a composition of the present disclosure 14. FIG. 2B illustrates another example of a modified surface 39. In this example, modified surface 39 includes a surface 30 with an outer layer 36. In this example, a composition of the present disclosure 34 is integrated into surface 30 and outer layer 36. FIG. 3C illustrates another example of a modified surface 49. In this example, modified surface 49 includes a surface 40 that contains a composition of the present disclosure 44 integrated into the surface. FIG. 4C illustrates another example of a modified surface 60. In this example, modified surface 60 includes a surface 50 with outer layer 56 that contains a composition of the present disclosure 54 integrated into the surface.

The modified surfaces of the present disclosure may include various concentrations of the compositions of the present disclosure. For instance, in some embodiments, the composition is at a concentration of at least about 0.1 ton per acre of the surface. In some embodiments, the composition is at a concentration of at least about 0.5 ton per acre of the surface. In some embodiments, the composition is at a concentration of at least about 1 ton per acre of the surface. In some embodiments, the composition is at a concentration of at least about 2 tons per acre of the surface. In some embodiments, the composition is at a concentration of at least about 2.5 tons per acre of the surface. In some embodiments, the composition is at a concentration of at least about 5 tons per acre of the surface. In some embodiments, the composition is at a concentration of at least about 7.5 tons per acre of the surface. In some embodiments, the composition is at a concentration of at least about 10 tons per acre of the surface. In some embodiments, the composition is at a concentration of at least about 25 tons per acre of the surface. In some embodiments, the composition is at a concentration of at least about 50 tons per acre of the surface. In some embodiments, the composition is at a concentration of at least about 75 tons per acre of the surface. In some embodiments, the composition is at a concentration of at least about 100 tons per acre of the surface.

In some embodiments, the modified surfaces of the present disclosure are associated with a field. In some embodiments, the field includes an agricultural field, a residential field, a golf course, a park, a sports facility, a yard, a highway, a subdivision, or combinations thereof. In some embodiments, the field includes a golf course. In some embodiments, the golf course includes a USGA accredited golf course.

In some embodiments, the modified surfaces of the present disclosure include a soil. In some embodiments, the soil includes, without limitation, top sand, topsoil, a turf, a managed turf, a soil layer below grass, or combinations thereof. In some embodiments, the surface includes a soil layer below grass. In some embodiments, the surface includes a soil layer below grass and its root zones.

In some embodiments, the composition improves the quality of the soil. For instance, in some embodiments, the improved soil quality includes at least one of nutrient enhancement, enhanced CO₂ capture, enhanced soil fertility, enhanced soil health, optimization of soil pH, or combinations thereof. In some embodiments the improved soil quality reduces or eliminates a need for the use of one or more soil nutrients, one or more soil fertilizers, additives (e.g., lime), or combinations thereof.

Methods of CO₂ Capture from an Environment

Additional embodiments of the present disclosure pertain to methods of capturing carbon dioxide (CO₂) from an environment. In some embodiments, such methods include exposing the environment to a composition of the present disclosure. Suitable compositions were described supra and are incorporated herein by reference. In some embodiments, the basalt sands in the compositions of the present disclosure capture the CO₂.

The methods of the present disclosure may be utilized to capture CO₂ from various environments. For instance, in some embodiments, the environment includes, without limitation, an airstream, a gas stream, an industrial plant, an atmosphere, ambient air, or combinations thereof. In some embodiments, the environment includes ambient air.

Various methods may also be utilized to expose an environment to a composition of the present disclosure. For instance, in some embodiments, the exposing occurs by flowing the environment through the composition. In some embodiments, the exposing occurs by placing the composition at or near the environment.

In some embodiments, the exposing occurs by applying the composition to a surface. Various methods may be utilized to apply the compositions of the present disclosure to a surface. For instance, in some embodiments, the application occurs by a method that includes, without limitation, spreading, pouring, sprinkling, spraying, or combinations thereof.

In some embodiments, the methods of the present disclosure also include a step of removing an outer layer of a surface prior to applying the composition to the surface. In some embodiments, the composition is placed on an outer layer of the surface.

The methods of the present disclosure may capture CO₂ from various surfaces. For instance, in some embodiments the surface includes soil. In some embodiments, the soil includes, without limitation, top sand, topsoil, a turf, a managed turf, a soil layer below grass, or combinations thereof. In some embodiments, the surface includes a soil layer below grass. In some embodiments, the surface includes a soil layer below grass and its root zones.

In some embodiments, the surface includes a field. In some embodiments, the field includes an agricultural field, a residential field, a golf course, a park, a sports facility, a yard, a highway, a subdivision, or combinations thereof. In some embodiments, the field includes a golf course. In some embodiments, the golf course includes a USGA accredited golf course.

The compositions of the present disclosure may be applied to surfaces at various concentrations for CO₂ capture. For instance, in some embodiments, the composition is applied at a concentration of at least about 0.1 ton per acre of the surface per year. In some embodiments, the composition is applied at a concentration of at least about 0.5 ton per acre of the surface per year. In some embodiments, the composition is applied at a concentration of at least about 1 ton per acre of the surface per year. In some embodiments, the composition is applied at a concentration of at least about 2 tons per acre of the surface per year. In some embodiments the composition is applied at a concentration of at least about 2.5 tons per acre of the surface per year. In some embodiments, the composition is applied at a concentration of at least about 5 tons per acre of the surface per year. In some embodiments, the composition is applied at a concentration of at least about 7.5 tons per acre of the surface per year. In some embodiments, the composition is applied at a concentration of at least about 10 tons per acre of the surface per year. In some embodiments, the composition is applied at a concentration of at least about 25 tons per acre of the surface per year. In some embodiments, the composition is applied at a concentration of at least about 50 tons per acre of the surface per year. In some embodiments, the composition is applied at a concentration of at least about 75 tons per acre of the surface per year. In some embodiments, the compositions of the present disclosure are applied at a concentration of at least about 100 tons per acre of the surface.

The methods of the present disclosure may be utilized to capture various types of CO₂. For instance, in some embodiments, the captured CO₂ includes atmospheric CO₂. In some embodiments, the captured CO₂ includes CO₂ embedded within a surface.

Without being bound by theory, CO₂ capture may occur by various mechanisms. For instance, in some embodiments, CO₂ capture may occur by at least one of sequestration, direct capture, adhesion, binding, adsorption, electrostatic interaction, or combinations thereof.

Without being bound by further theory, CO₂ capture may occur through various chemical reactions. For instance, in some embodiments, the CO₂ capture occurs by a reaction between at least one basalt sand, CO₂, and water. In some embodiments, the reaction releases one or more alkaline ions and mineralized bicarbonate (HCO₃⁻). In some embodiments, the reactions combine HCO₃⁻ with Ca²⁺ ions to produce stable CaCO₃ mineral.

Without being bound by further theory, CO₂ capture can occur through various reactions of silicate minerals, CO₂, and H₂O. For instance, in some embodiments where the basalt sand includes CaAl₂Si₂O₈, a CO₂ capture reaction can occur through the reaction shown in equation 1.

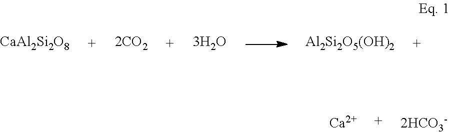

In some embodiments where the basalt sand includes NaAlSi₃O₈, a CO₂ capture reaction can occur through the reaction shown in equation 2.

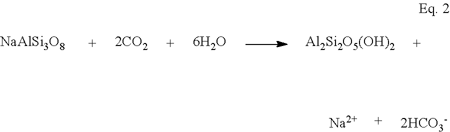

In some embodiments where the basalt sand includes (Ca, Mg)₂Si₂O₆, a CO₂ capture reaction can occur through the reaction shown in equation 3.

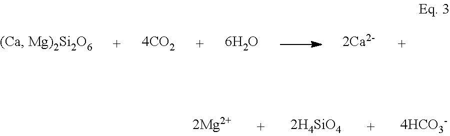

In some embodiments where the basalt sand includes (Mg, Fe)₂SiO₄, a CO₂ capture reaction can occur through the reaction shown in equation 4.

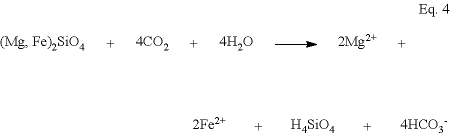

In some embodiments, atmospheric CO₂ removed by a CO₂ capture reaction is either retained as a long lived HCO₃⁻ or a CaCO₃ precipitate. In some embodiments, production of these compounds leads to net removal of atmospheric CO₂.

In some embodiments, Ca²⁺ and HCO⁻₃ react in accordance with equation 5 to result in the precipitation of CaCO₃.

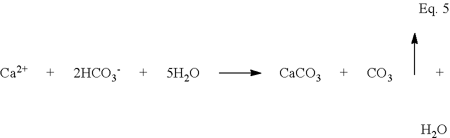 [SMILES: [Ca+2] ; "5H2O" ; "CaCO3" ; "CO3" ; O]

### Methods of Making Basalt Sand Compositions

Additional embodiments of the present disclosure pertain to methods of making the basalt sand compositions of the present disclosure. In some embodiments, such methods include crushing at least one basalt sand such that the crushing results in the formation of crushed basalt sand particles.

In some embodiments, the methods of the present disclosure also include a step of isolating, filtering and/or drying the basalt sand. In some embodiments, the methods of the present disclosure include a step of filtering basalt sand based on the particle size of the basalt sand. In some embodiments, the isolating occurs prior to the crushing. In some embodiments, the isolating includes purifying at least one basalt sand.

The methods of the present disclosure may be utilized to crush various basalt sands. Suitable basal sands were described supra and are incorporated herein by reference. For instance, in some embodiments, the basalt sands include, without limitation, plagioclase feldspars-containing basalts, pyroxenes-containing basalts, tholeiites, Holyoke Basalts, Blue Ridge Basalts, Butner Basalts, or combinations thereof. In some embodiments, at least one basalt sand includes a compound that includes, without limitation, CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄ or combinations thereof.

Various methods may be utilized to crush basalt sands. For instance, in some embodiments, the crushing occurs by methods that include, without limitation, grinding, sonicating, pounding, compressing, milling (e.g., ball milling and/or hammer milling), or combinations thereof. In some embodiments, the crushed particles are in the form of fine-grained particles, course particles, medium particles, course-grained particles, ultra-fine particles, nanoparticles, microparticles, or combinations thereof.

In some embodiments, the methods of the present disclosure also include a step of adding one or more additives to the basalt sand compositions. In some embodiments, the one or more additives include, without limitation, silicates, microbes, fungi, bacteria, actinomyces, biochar, golf course additives, peat moss, top sand, quartz-based top sands, lime, or combinations thereof.

The methods of the present disclosure can have numerous embodiments. For instance, depending on the moisture content of the sands, kilns or other drying methods may be needed to produce spreadable top sand.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1. Integrating Enhanced Rock Weathering (ERW) on Golf Courses

This Example describes the deployment of enhanced rock weathering (ERW) practices alongside existing turf management programs to demonstrate the viability of ERW as a CO₂ sequestration strategy for golf courses. This ERW strategy replaces traditional top sands with basalt sands for CO₂ capture.

Golf course construction typically entails a combination of subterranean drainage systems, irrigation, and the creation of an artificial topsoil consisting of a mixture of sand and soil to ensure proper drainage from the rootzone and base layer. In many cases, a “push-up green” is built with a custom blend of sand, peat moss (or other organic matter), and other additives. In some cases, a “sand-cap” is built over the existing sub-soil if the permeability is especially low. This is followed by layers of special soil, amended with sand to reduce the concentration of organic material (OM). An artificial topsoil may be necessary if the existing natural topsoil is too thin, lacking in nutrients, and/or over-compacted. Complete green construction guidelines are provided by the “USGA (2018). USGA Recommendations for a Method of Putting Green Construction.”

After the topsoil has been created, seeding takes place and the “establishment period” begins. The grass begins to grow and root structures develop.

Basalt sands could be integrated into existing golf course management programs. Moreover, when establishing a new course (or fully renovating an old course), designers can account for local conditions when integrating the basalt sands (e.g., climate, soil conditions, drainage, and/or local pests).

Basalt sands could be used in laying the foundation for the entire course, incorporating many tons of crushed basalts into the sand-based root zone, and providing nutrient benefits to the surrounding soils and grasses. Additionally, fine-grained basalt sands could be used at multiple points in the development process with especially large quantities used during rootzone construction in addition to top sanding practices. Both cases provide an opportunity to integrate basalts effectively.

The integration of basalt sands into the turf management programs at golf courses may be an optimal way to maximize the sequestration potential of golf courses. The highly managed soil structure of managed turf is ideally suited for enhanced rock weathering due to the high net primary productivity of the golf turf (estimated 1,100.5 g Carbon/m²/year), high volume of water flux from frequent irrigation, and existing systems for monitoring soil health, composition, and pH. (Wu, J., & Bauer, M. (2012). Estimating Net Primary Production of Turfgrass in an Urban-Suburban Landscape with QuickBird Imagery. Remote Sensing, Vol. 4, Issue 4, Pp. 849-866, 4, 849-866. https://doi.org/10.3390/rs4040849).

This process has the potential to sequester an estimated 26 to 340 metric tons of carbon dioxide per golf course via green top and course wide sanding annually, depending on the integration level. With around 15,000 plus golf courses spread across the United States, this works out to an annual capture of between 391,000 and 5.15 million metric tons of CO₂ per year from top dressing alone.

These figures are calculated in Table 3. The sand application rates are derived from (Whitlark & Thompson, 2019; USGA Green Section Record, 57(9). https://www.usga.org/content/usga/home-page/course-care/green-section-record/57/9/light-and-frequent-topdressing-programs.html) and the sequestration rate of 20% is a rounded estimate based on current CDR potential figures from scientific literature, such as the basalts used in the Reershemius paper, which shows a capture potential of 183.56 kgCO2 t⁻¹ (18.3%). This paper also discusses a potential method of measuring weathering based on a mass balance approach known as TiCAT. However, there are still questions regarding the effectiveness of this methodology (Reershemius, T., Kelland, M. E., Davis, I. R., D'Ascanio, R., Kalderon-Asael, B., Asael, D., Epihov, D. E., Beerling, D. J., Reinhard, C. T. and Planavsky, N. J., 2023. A new soil-based approach for empirical monitoring of enhanced rock weathering rates. arXiv preprint arXiv:2302.05004.).

Additional simulations run on the MatLab weathering model from the Leverhulme Institute provided similar capture potential estimates of between 15-20% when parameters similar to that of a golf course soil profile were used. (Beerling et al., 2020, Nature, 583(7815), 242-248. https://doi.org/10.1038/s41586-020-2448-9; P. Renforth, 2012, International Journal of Greenhouse Gas Control, 10, 229-243). These estimates differ from the results in the lab experiment Applicants conducted using basalts from the Pioneer Valley.

Regardless, in order to effectively measure and verify the amount of CO₂ captured when basalt sands are deployed in the field, a reliable system of measurement must be developed. This verification process may include a variety of testing at individual courses. Various methods of measurement including, but not exclusive to, soil sampling, testing, other analyses, chemical testing, other laboratory or field-based testing, as well as sampling of water from existing drainage pipes and other sources around the course exist to conduct tests and analysis to verify weathering as well as the amount of CO₂ sequestered.

Tables 3-4 show the estimated values of carbon captured from golf courses.

TABLE 3
Sand Use Estimates based on current industry top sand application
rates and estimated CO₂ Sequestration per golf course annual application.
Calculations: Golf Course Annual Sand Use & CO2 Sequestration Potential Estimate

| | | Sequestration Rate: 20% | | met. T_{CO2} / met. T_{Basalt} |
|---|---|---|---|---|
| Course Adoption Level | lbs/ 1,000 | met. Tons/ | metric tons of | CO2 Sequestration |
| Greens only | sq ft/ year | hectare/ year | Basalt/ year | Potential (metric tons) |
| Aeration Backfill | 1,200.0 | 58.59 | 71.1 | 14.2 |
| Regular Topsanding | 1,000.0 | 48.82 | 59.3 | 11.9 |
| Increased Topsanding | 2,000.0 | 97.65 | 118.6 | 23.7 |
| Aeration & Regular Topsanding | 2,200.0 | 107.41 | 130.4 | 26.1 |
| Aeration & Increased Topsanding | 3,200.0 | 156.24 | 189.7 | 37.9 |

| | Tons/ Acre/ | met. Tons/ | metric tons of | CO2 Sequestration |
|---|---|---|---|---|
| Fairways Only | year | hectare/ year | Basalt/ year | Potential (metric tons) |
| Lower Bound Topsanding | 30.0 | 67.3 | 764.8 | 153.0 |
| Upper Bound Topsanding | 60.0 | 134.5 | 1529.5 | 305.9 |

Total (Greens & Fairways - Combined)

| | | CO2 Sequestration |
|---|---|---|
| | metric tons | Potential (metric |
| | of Basalt | tons/ year application) |
| Full Implementation | 895.2 | 179.0 |
| Intensive Implementation | 1,719.2 | 343.8 |

TABLE 4
Estimated range of value of Carbon Credits per golf course
depending on the course integration level in USD($).

| Offset Potential | Carbon Offset Price | | |
|---|---|---|---|
| (met. Tons_{CO2}) | $100 | $150 | $200 |

Greens only

| | | | | |
|---|---|---|---|---|
| Aeration Backfill | 14.2 | $1,422.61 | $2,133.92 | $2,845.23 |
| Regular Topsanding | 11.9 | $1,185.51 | $1,778.27 | $2,371.02 |
| Increased Topsanding | 23.7 | $2,371.02 | $3,556.53 | $4,742.04 |
| Aeration & Regular | 26.1 | $2,608.12 | $3,912.19 | $5,216.25 |
| Aeration & Increased | 37.9 | $3,793.64 | $5,690.45 | $7,587.27 |

Fairways Only

| | | | | |
|---|---|---|---|---|
| Regular Topsanding | 153.0 | $15,295.14 | $22,942.71 | $30,590.28 |
| Increased Topsanding | 305.9 | $30,590.28 | $45,885.42 | $61,180.56 |

Total (Combined Programs)

| | | | | |
|---|---|---|---|---|
| Full Implementation | 179.0 | $17,903.26 | $26,854.90 | $35,806.53 |
| Intensive Implementation | 343.8 | $34,383.91 | $51,575.87 | $68,767.83 |

The integration of basalt sands into the turf management practices of golf courses can be accomplished within existing infrastructure via putting green top sanding and aeration programs or through fairway top sanding. Although fairway top sanding and aeration is less common, recent golf turf grass studies emphasize the benefits of frequent and finer top sand applications to both greens and fairways. The adoption of course-wide top sanding significantly raises the sequestration opportunity to around 340 metric tons of CO₂ per year. Depending on the course, basalt sands could also be used during construction or renovation to sequester greater amounts of CO₂ once efficacy can be proven.

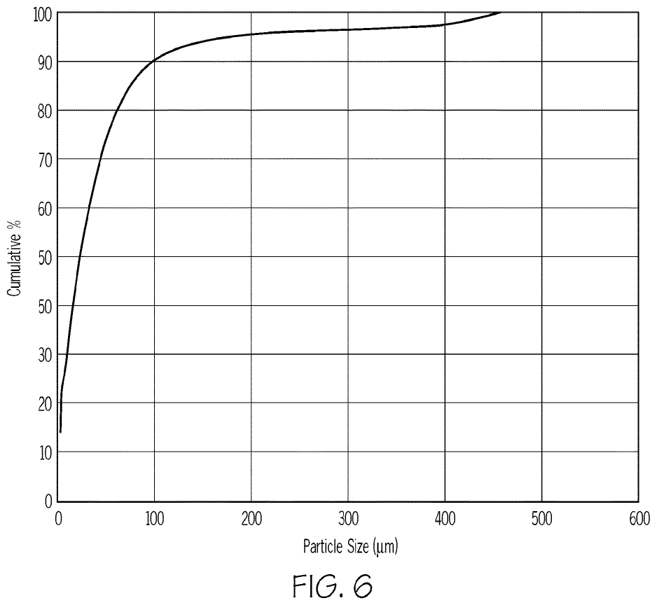

To evaluate the extent to which alkalinity is released from basalt weathering, Applicants purchased rock powder Pioneer Valley basalt from Rock Dust Local (rockustlocal.com). This basalt is nearly identical in its chemical composition to that of Holyoke Basalt and has a maximum enhanced weathering CO2 capture potential of 203 kg CO₂ t⁻¹. The rock powder was dried and sieved. The particle size distribution of the rock power is shown in FIG. 6.

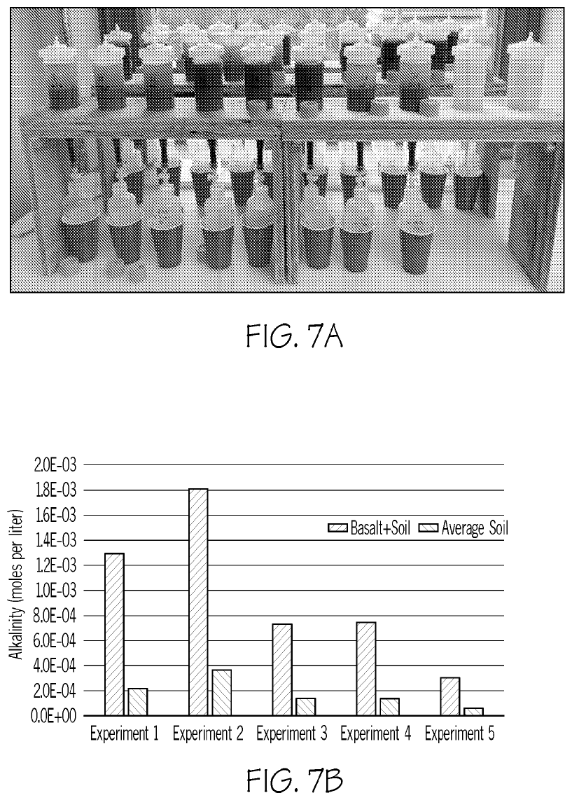

The basalt powder was mixed with sieved and dried soil from Dartmouth Organic Farm in a ratio of 10 g basalt to 170 g soil and packed in a Biorad® column to a height of ~6 cm. The soil used is Windsor loam. It is quite infertile and has not been fertilized. The column area is 23.76 cm², meaning that the amount of basalt added is equivalent to 19 US ton/acre. As a control, 180 g of the same soil was also packed in columns as shown in FIG. 7A. Water passed through the columns was weighed and measured for Na, K, Ca, and Mg. The alkalinity of the solution was also calculated.

Experiments conducted over 3 months show that, with reference to the controls, the soil amended with basalt powder releases five-times more alkalinity (FIG. 7B). The data show that the basalt amended soil consumes 1.94 g of CO₂ per 10 g of basalt (19.4% consumption) in comparison to soil control. This is equivalent to consumption of 194 kg of CO₂ t⁻¹ of basalt and approaches the theoretical maximum enhanced weathering CO₂ capture potential for this rock. Additionally, the results are summarized in Table 5.

TABLE 5
Changes in Alkalinity of effluent from basalt amended soil
columns with reference to soil controls show that, on
average, 19.4% of basalt was weathered over 88 days when
5 different elution experiments were conducted. Due to
the time lag between experiments the total duration of
experiments was about six months (May 2023-October 2023).

| | | CO₂ | CO₂ | |
|---|---|---|---|---|
| | Δ | consumed | consumed | % |
| Experiment | Alkalinity | (moles) | (g) | yield |
| 1 | 5.47 E−04 | 0.012 | 0.53 | 5.3 |
| 2 | 3.95 E−03 | 0.087 | 3.82 | 38.2 |
| 3 | 3.15 E−03 | 0.069 | 3.05 | 30.5 |
| 4 | 1.50 E−03 | 0.033 | 1.45 | 14.5 |
| 5 | 8.67 E−04 | 0.019 | 0.84 | 8.4 |
| Average | | | 1.94 | 19.4 |

While Applicants' assessment of CO₂ consumption per metric ton of basalt matches well with that recently reported experiment conducted over 4 years in an agricultural farm in Illinois (Beerling, D. J. et al. (2024) Enhanced weathering in the US Corn Belt delivers carbon removal with agronomic benefits, Proc. Nat. Acad. Sci., 121(9), e2319436121, https://doi.org/10.1073/pnas.2319436121), Applicants expect that the total CO₂ consumed would be much higher in the golf courses, reaching the theoretical CO₂ capture potential due to high temperatures and higher amounts of organic matter present in soil.

Tables 6 and 7 provide general guidelines for top sands and USGA recommended root zones, respectively. Tables 6 and 7 provide recommended particle size distribution for a USGA approved Green rootzone construction, as well as a finer top sand blend that is based on the rootzone sand but with less coarse particles and more fine, ultra-fine, and other small particle sizes. A recent article (Whitlark & Thompson, 2019; USGA Green Section Record, 57(9). https://www.usga.org/content/usga/home-page/course-care/green-section-record/57/9/light-and-frequent-topdressing-programs.html) provided additional guidelines: “A general guideline is to select a sand that has a minimum of 50 percent of its particles in the medium-sized fraction (0.25-0.50 millimeters (mm) in diameter) and 15 to 40 percent in the coarse fraction (0.5-1.0 mm in diameter). The fine sand fraction (0.15-0.25 mm) should not exceed 25 percent, and the very fine fraction (0.05-0.15 mm) should not exceed 5 percent. Ideally, the material should have no particles greater than 1.0 mm in diameter given the difficulty in getting these larger particles to work down into the turf canopy. It is recommended to use a material with a coefficient of uniformity (CU) greater than 1.8. If the sand is too narrowly graded, which will produce a low CU, this may result in soft, unstable surfaces. However, the CU is not the only determining factor in stability—sand shape also plays a role, with angular sands being more stable. Utilizing a coarser sand during aeration will create more stability.”

TABLE 6
General guidelines for top sands.
Typical Top sand Guidelines

| | | | | | Example | Example |
|---|---|---|---|---|---|---|
| | | | | | Product | Product |
| PARTICLE | DIAMETER | | SIEVE | % BY WEIGHT | (standard) | (fine) |
| Course | 0.5-1.0 | mm | No. 35 | 15-40% course | 15% | 5% |
| Medium | 0.25-0.50 | mm | No. 60 | 50% minimum | 50% | 25% |
| Fine | 0.15-0.25 | mm | No. 100 | 25% maximum | 25% | 55% |
| Very fine | 0.05-0.15 | mm | No. 270 | 5% maximum | 5% | 10% |
| silt (other fine) | 0.002-0.05 | mm | | n/a | 5% | 5% |

TABLE 7
General guidelines for USGA recommended root zones.
USGA Recommended Rootzone

| PARTICLE | DIAMETER | | SIEVE | % BY WEIGHT |
|---|---|---|---|---|
| Coarse gravel | >4 | mm | No. 5 | 0% |
| Fine gravel | 2.0-3.4 | mm | No. 10 | ≤3% gravel |
| Very coarse sand | 1-2 | mm | No. 18 | ≤10% combined |
| Coarse sand | 0.5-1.0 | mm | No. 35 | ≥60% |
| Medium sand | 0.25-0.5 | mm | No. 60 | ≥60% |
| Fine sand | 0.15-0.25 | mm | No. 100 | ≤20% |
| Very fine sand | 0.05-0.15 | mm | No. 270 | ≤5% |
| Silt | 0.002-0.05 | mm | | ≤5% |
| Clay | <0.002 | mm | | ≤3% |

| | | |
|---|---|---|
| Total fines | Very fine sand + | ≤10% combined |
| | silt + clay | |

| | | |
|---|---|---|
| Coefficient of | 1.8-3.5 | Rootzone mixtures w/ peat |
| Uniformity | 2.0-3.5 | Rootzone w/ inorganic amendments |
| (D60/D10) | 2.0-3.5 | Pure sand rootzone w/ mixtures |

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of capturing carbon dioxide (CO₂) from an environment, said method comprising: exposing the environment to a composition, wherein the composition comprises at least one basalt sand in the form of crushed particles, and wherein the at least one basalt sand captures the CO₂.

2. The method of claim 1, wherein the at least one basalt sand is in purified form.

3. The method of claim 1, wherein the at least one basalt sand comprises a plurality of different types of basalt sands.

4. The method of claim 1, wherein the at least one basalt sand is selected from the group consisting of plagioclase feldspars-containing basalts, pyroxenes-containing basalts, tholeiites, Holyoke Basalts, Blue Ridge Basalts, Butner Basalt, or combinations thereof.

5. The method of claim 1, wherein the at least one basalt sand comprises Holyoke Basalt.

6. The method of claim 1, wherein the at least one basalt sand comprises a compound selected from the group consisting of CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄, or combinations thereof.

7. The method of claim 1, wherein the composition further comprises one or more additives selected from the group consisting of silicates, microbes, fungi, bacteria, actinomyces, biochar, golf course additives, peat moss, top sand, quartz-based top sands, lime, or combinations thereof.

8. (canceled)

9. The method of claim 1, wherein the exposing comprises:
removing an outer layer of a surface, and
applying the composition to the surface, wherein the surface comprises a soil, a field, or combinations thereof.

10-11. (canceled)

12. The method of claim 9, wherein the composition is applied at a concentration of at least about 25 ton per acre of the surface per year.

13. (canceled)

14. The method of claim 9, wherein the surface comprises a soil selected from the group consisting of top sand, topsoil, a turf, a managed turf, a soil layer below grass, or combinations thereof.

15. The method of claim 9, wherein the surface comprises a soil layer below grass.

16. The method of claim 9, wherein the surface comprises a field selected from the group consisting of agricultural field, a residential field, a golf course, a park, a sports facility, a yard, a highway, a subdivision, or combinations thereof.

17. (canceled)

18. The method of claim 16, wherein the field comprises a golf course.

19. The method of claim 1, wherein the CO₂ comprises atmospheric CO₂.

20. The method of claim 1, wherein the CO₂ capture occurs by a reaction between the at least one basalt sand, CO₂, and water, wherein the reaction releases one or more alkaline ions and mineralized bicarbonate (HCO₃⁻).

21. A method of modifying a surface, said method comprising:
applying a composition comprising at least one basalt sand to the surface, wherein the at least one basalt sand is in the form of crushed particles.

22. The method of claim 21, wherein the at least one basalt sand is in purified form.

23. The method of claim 21, wherein the at least one basalt sand comprises a plurality of different types of basalt sands.

24. The method of claim 21, wherein the at least one basalt sand is selected from the group consisting of plagioclase feldspars-containing basalts, pyroxenes-containing basalts, tholeiites, Holyoke Basalts, Blue Ridge Basalts, Butner Basalt, or combinations thereof.

25. The method of claim 21, wherein the at least one basalt sand comprises Holyoke Basalt.

26. The method of claim 21, wherein the at least one basalt sand comprises a compound selected from the group consisting of CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄, or combinations thereof.

27. The method of claim 21, wherein the composition further comprises one or more additives selected from the group consisting of silicates, microbes, fungi, bacteria, actinomyces, biochar, golf course additives, peat moss, top sand, quartz-based top sands, lime, or combinations thereof.

28. (canceled)

29. The method of claim 21, wherein the exposing comprises:
removing an outer layer of the surface, and
applying the composition to the surface, wherein the surface comprises a soil, a field, or combinations thereof.

30-31. (canceled)

32. The method of claim 29, wherein the composition is applied at a concentration of at least about 25 tons per acre of the surface per year.

33. The method of claim 29, wherein the surface comprises soil selected from the group consisting of top sand, topsoil, a turf, a managed turf, a soil layer below grass, or combinations thereof.

34. (canceled)

35. The method of claim 29, wherein the surface comprises a soil layer below grass.

36. The method of claim 29, wherein the surface comprises a field selected from the group consisting of an agricultural field, a residential field, a golf course, a park, a sports facility, a yard, a highway, a subdivision, or combinations thereof.

37. (canceled)

38. The method of claim 36, wherein the field comprises a golf course.

39. A modified surface, wherein the modified surface comprises a composition, wherein the composition comprises at least one basalt sand, wherein the at least one basalt sand is in the form of crushed particles.

40. The modified surface of claim 39, wherein the at least one basalt sand is in purified form.

41. The modified surface of claim 39, wherein the at least one basalt sand comprises a plurality of different types of basalt sands.

42. The modified surface of claim 39, wherein the at least one basalt sand is selected from the group consisting of plagioclase feldspars-containing basalts, pyroxenes-containing basalts, tholeiites, Holyoke Basalts, Blue Ridge Basalts, Butner Basalt, or combinations thereof.

43. The modified surface of claim 39, wherein the at least one basalt sand comprises Holyoke Basalt.

44. The modified surface of claim 39, wherein the at least one basalt sand comprises a compound selected from the group consisting of CaAl₂Si₂O₈, (Ca, Mg)₂Si₂O₆, (Mg, Fe)₂SiO₄, NaAlSi₃O₈, (Ca,Mg)SiO₃, (Fe,Mg,Ca)₂SiO₄, or combinations thereof.

45. The modified surface of claim 39, wherein the composition further comprises one or more additives selected from the group consisting of silicates, microbes, fungi, bacteria, actinomyces, biochar, golf course additives, peat moss, top sand, quartz-based top sands, lime, or combinations thereof.

46. (canceled)

47. The modified surface of claim 39, wherein the composition is positioned on an outer layer of the surface.

48. The modified surface of claim 39, wherein the composition is at a concentration of at least about 25 tons per acre of the surface.

49. The modified surface of claim 39, wherein the surface comprises soil selected from the group consisting of top sand, topsoil, a turf, a managed turf, a soil layer below grass, or combinations thereof.

50. (canceled)

51. The modified surface of claim 49, wherein the soil comprises a soil layer below grass.

52. The modified surface of claim 39, wherein the surface is associated with a field selected from the group consisting of an agricultural field, a residential field, a golf course, a park, a sports facility, a yard, a highway, a subdivision, or combinations thereof.

53. (canceled)

54. The modified surface of claim 52, wherein the field comprises a golf course.
